(19) United States
(12) Patent Application Publication
(10) Pub. No.: US 2010/0148483 A1
(43) Pub. Date: Jun. 17, 2010

(54) Sports Equipment and Method for Designing its Visual Appearance

(76) Inventors: Ralf Kopp, Darmstadt (DE); Marc Bartolo, Darmstadt (DE)

Correspondence Address: LERNER GREENBERG STEMER LLP, P O BOX 2480, HOLLYWOOD, FL, 33022-2480, US

(21) Appl. No.: 12/517,638

(22) PCT Filed: Oct. 26, 2007
(86) PCT No.: PCT/EP07/09517

§ 371 Date: Feb. 19, 2010

(30) Foreign Application Priority Data
Dec. 4, 2006 (DE) 10 2006 057 725.6

(51) Int. Cl. A63C 11/00; G09G 3/30

(52) U.S. Cl. 280/809; 345/76

(57) ABSTRACT

An item of sports equipment includes a board with an upper surface and an opposite lower surface. The sporting appliance has at least one image display device which is configured to display an at least two-dimensional image which can be seen on viewing the upper surface, the lower surface, and/or a side surface of the board.

The invention relates to a sports equipment item having a board and to a method for configuring the visual appearance of the sports equipment item.

Board-like sports equipment items, such as skateboards, snowboards or surfboards, are used primarily by young people who play sport. There is often a desire for an up-to-date and unusual design for the external visual appearance of the sports equipment item. A design which is up to date and suits the tastes of the buying public in one year may be perceived as boring and outdated as early as the next year. In addition, those playing sport will often like to use a board with a unique design which is different from all other boards. Paints and finishes applied by the user himself have been found to have little permanence, however. It is also unacceptable from environmental aspects for the paint to come off and be distributed over the piste or in the water.

US 2002/0018345 A1 discloses an illuminated board-like sports equipment item which has an electroluminescent layer which is covered by a translucent layer at the top. By switching a power supply on and off, the luminescent layer can be illuminated and switched off, respectively. Although this allows lighting effects to be achieved, the two possible design states (illuminated and unilluminated state) are fixed from the outset.

It is an object of the present invention to specify a sports equipment item which has a board whose visual appearance can be configured differently in a wide variety of ways despite identity of design. It is a further object of the present invention to specify a method for configuring the visual appearance of a sports equipment item.

It is proposed that the sports equipment item have at least one image presentation device which is designed to present an at least two-dimensional image which can be seen when viewing the top surface of the board and/or the bottom surface of the board. The image presentation device is able to present different images. Preferably, it is able to present any, freely prescribable images.

The term “images” is not limited to images in the sense of photographs, views of real or fictitious scenes or paintings. Instead, it is possible for all conceivable two-dimensional or three-dimensional image contents to be presented by the image presentation device. It is also possible for available images, which are defined by a set of image data, for example, letters, numbers, lines and other structure elements or other image contents to be superimposed, so that it is possible for any graphically presentable information to be displayed to the viewer.

By way of example, in an emergency, the letter sequence “SOS” can be presented by the image presentation device. The fact that there is an emergency is established by a sensor in the sports equipment item, for example, which then automatically triggers the presentation of the emergency image. This allows an increase in safety for the user when playing the sport. Optionally, the emergency can be sent (e.g. to a base station in a mobile telephone network) by means of a transmission device in the sports equipment item.

However, it is also possible to present an emergency message other than “SOS”. The chronological sequence of images which are presented by the image presentation device can also indicate the emergency. By way of example, the effect of an indicator (on off on etc.) can be produced and/or light signals comprising the presented images can be used to send a Morse code.

It is also possible for a rescue station which has been set up specifically for receiving emergency radio messages to receive the emergency message sent by the transmission device in the sports equipment item.

The sensor which automatically recognizes the emergency situation or is optionally operated by a person may be a pressure sensor or an acceleration sensor, for example, which triggers the described emergency reaction when a prescribed limit value (for the pressure or the acceleration) is exceeded.

The image presentation device may also be in a form such that the presented images can be seen in addition to or as an alternative to the top surface and/or the bottom surface when viewing a lateral face of the board.

Apart from a transmission device for the sports equipment item to communicate wirelessly with its environment, which is designed not just or else not at all for the emergency, the sports equipment item may alternatively or additionally have a reception device for receiving signals transmitted to the sports equipment item by radio. The transmission format for sent and/or received signals may correspond to the Bluetooth standard, for example, a mobile telephone standard (e.g. GSM or UMTS). However, the signals may also be infrared signals. The messages themselves which are transmitted by the signals may be SMS (short message service) messages or MMS (multimedia messaging service) messages. Particularly in the case of an MMS, image contents for presenting the images can be transmitted by the image presentation device from the sports equipment item to another device or vice versa. In this way, it is thus particularly possible for new image contents or portions of images to be transmitted to the sports equipment item.

However, it is also possible for image contents or portions of images to be transmitted to the sports equipment item in another way, for example by a cable link which corresponds to the USB (Universal Serial Bus) standard. In addition, it is possible for the sports equipment item to have a receptacle and/or a connection for the purpose of receiving or connecting a storage medium which stores the image content(s) which is/are presented or can be presented by the image presentation device. It is also possible for image contents (for example along a ski slope) to be stored in an appropriate device and for the sports equipment item to retrieve these image contents automatically when passing the respective device, so that they are transmitted to the sports equipment item.

Image contents which may have a format designed specifically for the presentation of the image presentation device, for example, are provided, in one embodiment of the invention, for the purpose of download from a provider device and are transmitted thereto depending on the type of transmission technology available in the sports equipment item. This makes it possible to achieve similar customer loyalty structures to those in the case of ringtones for mobile telephones.

It is also possible for new firmware or software for the operation of the transmission device and/or image presentation device of the sports equipment item to be transmitted to the sports equipment item in the same ways as described above for the transmission of image contents.

The sports equipment item has a board, e.g. a snowboard, skateboard, wind or water surfboard, ski, monoski, water ski, sandboard, kiteboard, wakeboard or kneeboard. The board has a top, usually (as in the case of a snowboard) large-area surface on which a binding can be arranged, and a bottom surface (on the underside of the board) which may be in the form of a running surface and in this case improves the board's sliding over a subsurface, e.g. over snow, water, sand. There may be a lateral edge surface present, the height of which is the same as the thickness (i.e. the interval between the top and bottom surfaces) of the board. In most embodiments which are customary today, the board has rounded corners and/or curvatures at the transitions between the lateral surfaces and the other surfaces and/or in their profile around the body of the board. The lateral edge surface can be referred to as flat, since its height is smaller than at least the length of the top and bottom surfaces and/or usually also smaller than the width of the top and bottom surfaces. The lateral edge surface merges into the top surface at the top and/or adjoins the surface and merges into the bottom surface at the bottom and/or adjoins the bottom surface. Alternatively, it is possible for the interval between the top and bottom surfaces (at least in an edge region) to be reduced in their profile toward the edge of the board until the top and bottom surfaces merge into one another and/or adjoin one another. In this case, there is no clearly delimited lateral edge face present at least in this edge region.

The board may also be curved and/or angled off in places or overall, so that the top or bottom surface does not run within one plane. By way of example, snowboards are curved at the front and rear ends. The board may also be tapered, have recesses and/or have projections on at least one side.

The image presentation device may, by way of example, have one or more displays and one common or a plurality of control devices for controlling the presentation of image contents on the displays or on the display. By way of example, a first display may be arranged in the board such that the image area which can be presented by the display extends along the top surface of the board and allows the presented image or the images to be viewed through a translucent cover on the display, for example. Accordingly, a display may alternatively or additionally be arranged so as to run along the bottom surface of the board, so that it is possible to view the image contents through a transparent cover on the bottom surface.

As yet another alternative or addition, it is also possible for one or more displays to be provided which allow image contents to be viewed by viewing the lateral face of the board. There may also be optical means such as mirror coatings present in the board, so that at least portions of presented images are deflected to an outer surface of the board (e.g. diffracted by a lens or reflected by an element). The respective display therefore does not necessarily need to extend along the surface through which the image can be viewed.

In principle, is also possible for the display itself to form the outer surface at least in a subregion of the board. This may be the case particularly when the display itself is provided with a protective surface layer, so that the actual image presentation elements are protected. However, it is preferred for the aforementioned transparent protective layer or a transparent protective material to be situated between the outer surface and the display. In particular, it is also possible for various transparent materials to be situated between the display on the outer surface.

The display(s) can extend over the entire length and/or width of the respective side of the board (i.e. the top surface, the lateral face or the bottom surface). It is therefore possible for the display to present an image which can have its full area perceived through the entire top surface or bottom surface, with portions of the image being able to be covered by bindings in a central region of the surface, for example. Alternatively, it is possible for a display to present images only such that they can be perceived through a subregion of one of said surfaces or are presented only on the subregion of the surface.

It is preferred for the image presentation device to have at least one matrix which is formed from light-emitting diodes. In particular these may be light emitting diodes which are arranged in rows and columns of the matrix. Yet another preference is for the light-emitting diodes to be organic light-emitting diodes (OLEDs). Yet more especially, it is preferred for the matrix to be flexible, i.e. to be required to bend, in particular. Specifically, “flexible” is intended to mean that the board together with the display arranged thereon or therein can be subjected to elastic, reversible deformation without the matrix or another flexible display being damaged or destroyed thereby. In this case, the display does not itself need to keep shape such that it applies elastic restoring forces to restore the original shape. Rather, it must merely be possible for this deformation to be able to yield to the deformation of the entire board without becoming damaged or destroyed.

In particular, it is possible (this is also discussed in the description of the figures) for the matrix to be arranged as a layer or in a layer of the board, with the layer extending along the top surface and/or along the bottom surface of the board. Preferably, the matrix defines an image area for presenting images which extends over at least 50% of the width or at least 50% of the length of the top surface and/or the bottom surface. The image area can extend particularly over the entire width and the entire length of the top surface and/or the bottom surface. In one advantageous refinement of the sports equipment item, the at least one display of the image presentation device is fully integrated in the board, i.e. the board has the same shapes and/or dimensions in comparison with a refinement of the board without an image presentation device. However, it goes without saying that there may be design alterations particularly for the dimensions as a result of the fact that the image presentation device and optionally the aforementioned transmission device and also optionally further devices result in an at least slightly increased space requirement within the board and/or mean that said additional devices do not have the same mechanical properties as materials which are usually present in a board.

By way of example, as already mentioned, the image presentation device may have a control device which can control which image or which images the image presentation device presents, wherein the sports equipment item has a reception device for receiving image data and wherein the control device is designed to prompt the presentation of received image data by the image presentation device.

However, there is a further additional or alternative option for image contents which are presented or which are to be presented being influenced by externally received signals. In one alternative or additional refinement, the sports equipment item therefore has the image presentation device with the control device which can control which image or which images the image presentation device presents, wherein the sports equipment item has a reception device for receiving control information and wherein the control device is designed to prompt the presentation of images on the basis of the received control information. By way of example the control information may be selection commands for selecting particular image contents which are then presented by the image presentation device.

In addition, the scope of the invention includes a method for configuring the visual appearance of a sports equipment item which has a board having a top surface and an opposite bottom surface. Images are presented by an image presentation device of the sports equipment item so that at least one image can be seen when viewing the top surface, the bottom surface and/or a lateral face of the board.

For the description of the advantages and possible refinements and variants of the method, reference is made to the description of the sports equipment item.

Further refinements, variants and exemplary embodiments of both the sports equipment item and the method are described below.

The sports equipment item may have a receiver for receiving signals from a position-finding system, particularly a satellite-based position-finding system such as the GPS or Galileo. Information about the current position of the sports equipment item or signals from which the position can be determined may alternatively be received in another way, particularly using a radio link based on the Bluetooth standard. Such signals can also be received using a link in a mobile telephone network. The position, which can be determined repeatedly or continuously, for example, is of particular advantage for navigation within a ski area. The image presentation device can, for example at the front end of a snowboard in the direction of travel use one or more images to show the direction in which a destination or possible destination for the snowboard journey is located. In particular, it is possible, by way of example, for the image presented by the image presentation device to indicate the direction in which an easy piste (for example shown by a blue arrow) is situated and the direction in which a piste with a medium degree of difficulty (e.g. shown by a red arrow) is situated. It goes without saying that other degrees of difficulty for ski descents or routes for the use of other kinds of boards (e.g. windsurfing board) can be indicated by an image presented by the image presentation device. Apart from an arrow presentation, it is also possible, in particular, to show the profile of routes. Apart from the routes or directions of routes, it is also possible for the position and/or direction of facilities, such as a ski but or a restaurant, to be presented by the image presentation device. Examples of other possible facilities are valley stations for ski lifts and/or the current position of other sports equipment items (on which friends or relatives, for example, are on the move as people playing sport). Within the context of or in connection with position-finding and/or navigation, it is also possible for other images and/or information to be presented graphically, such as those images and/or information which are customary in similar fashion for navigation in road traffic, for example. This information and/or these images include route or land maps or details therefrom, in particular. Independently of or in connection with the navigation, it is also possible for the current weather conditions or weather forecast, for example, to be presented graphically by the presentation device. In connection with the navigation, it is also possible for information and advertising contents in said device to be presented graphically. In this case, information is already present in the sports equipment item and/or is transmitted to the sports equipment item at a suitable time or when a particular position is reached. The same applies to the advertising contents. It is therefore possible to take the position of the sports equipment item as a basis (and optionally even to take the direction in which the sports equipment item is moving as a basis) for receiving the information and/or advertising contents and/or presenting them as an image on the sports equipment item.

However, the presentation of information, and/or advertising contents is also possible independently of the position or navigation. This does not require a position-finding system to be present at all or it to be possible to determine the position for the sports equipment item. The advertising contents can be presented on the sports equipment item by means of animated (i.e. particularly by image presentation which changes over time) or by means of static images, for example. The advertising may be advertising for sports events close to the sports equipment item, for example, or else advertising for the board manufacturer, for a ski hut, bar or restaurant, for example.

By way of example, the current, particularly cheap price of a bar can be presented by the image presentation device, for example Almdudler only EURO 3.00 in but XY today. The advertising or other information can be presented not only while the sports equipment item is being used, but also when the sports equipment item is for sale in a sports shop, for example. Particularly for this purpose, but also for other opportunities, the image content which is presented on a single sports equipment item may have been coordinated with the image content of other similar or different sports equipment items or else may have been coordinated with the image contents of other devices. It is therefore possible for only a portion of an overall image to be presented on a particular sports equipment item and for the overall image or at least large portions thereof to be possible not only for viewing the particular sports equipment item but also its environment. By way of example, a plurality of snowboards or skateboards can be set up next to one another with various image elements from the overall image being respectively presented on the individual sports equipment items.

Other options for information which is presented by the presentation device on a single sports equipment item are, for example during a sports event, the national flag, the current position the race, the position of the opponents and/or other information relating to the sports event. Furthermore, it is also possible for technical information and information about the behavior and/or physiological variables of the person playing sport to be presented on the sports equipment item by the image presentation device, for example the loading on the board (i.e. forces, accelerations and/or deformations). For the purpose of measuring the loading or other values which affect the sports equipment item, it is possible for there to be one or more relevant sensors integrated in the board. For the purpose of measuring physiological variables for the user or variables which affect the movement of the user, there may be at least one sensor outside of the sports equipment item, the signals from which can be transmitted to the sports equipment item, however. In addition, the sports equipment item may optionally have a data store which is used to store the sensor signals and/or measured values as a function of time, for example. Such storage allows subsequent retrieval of the measured values and analysis. At least some of the evaluation of the signals can also take place in the sports equipment item itself, however, which to this end has a microprocessor, for example. The evaluation or evaluation element can be effected by hardware and/or software.

The sensors, the data store or the data stores and/or the evaluation device may be integrated in the board, may be arranged in or on another portion of the sports equipment item (e.g. on a binding for holding a sports shoe) and/or may not be arranged on the sports equipment item or in the sports equipment item. The required links for transmitting signals and/or data may be in the form of radio links (these are also understood to mean infrared links, for example) and/or cable links. By way of example, some of said devices may be arranged in the sports shoe and may be electrically connected to the binding by means of contacts or cables for the purpose of transmitting the signals or data.

Further devices, which may be arranged like the devices already cited previously and may be coupled for the purpose of transmission are, by way of example, the control device for controlling which image contents are presented on the sports equipment item, a media player, a receiver for receiving signals from devices further away, a receiver for receiving signals for position finding (e.g. a GPS receiver), a computer (particularly a microcomputer) and/or illumination and/or display devices which are provided in addition to the image presentation device. In addition, provision needs to be made for said devices to be supplied with power, so that one or more electrical and/or electrochemical energy stores can be provided. In particular, at least some of the devices may be arranged in the clothing or on the clothing of the user.

However, a fundamental advantage of the invention even in the case of the simplest refinement of the sports equipment item is that the visual configuration of the board can be adjusted and changed by means of appropriate refinement or adjustment of the image presentation device. If the image presentation device has the option of being operated after it has been finished, so that the images presented by it can be changed or can be exchanged, then it is even possible for the user or, by way of example, a specialist in a sports shop to change the image contents presented or to be presented. This allows an individual design. It is also possible for the respective design to be swapped with the owners of other sports equipment items or for commercial providers of such designs to provide image data for purchase.

In particular, a piece of software which allows image contents to be changed and/or created for presentation on the sports equipment item may be provided for the purpose of operating the image presentation device.

The image presentation device can also be used by the user in order to participate in games and/or competitions. By way of example, it is thus possible, when using a snowboard, to take on an unknown or known opponent, with images or image sequences being presented on the snowboard during the use of the snowboard which correspond to the respective situation in the competition.

In addition, the image presentation device may have an interface with allows it to be connected to a games console. The games console can be operated during use of the sports equipment item or during a break. In particular, the image contents which are presented on the sports equipment item can be prescribed by the games console directly.

Instead of or in addition to the games console, it is also possible to connect another device or for another device to have been connected which prescribes the image contents presented or to be presented, for example a television, a video player or another media appliance. This applies particularly to the aforementioned situation in which only a content element from an overall image is presented on a particular sports equipment item. A computer (e.g. desktop computer) can also be connected to the sports equipment item(s) in order to prescribe the image contents to be presented thereon. The image presentation device of a board or the image presentation devices of a plurality of boards can thus be used to put on a light show while music is being played, for example, and/or to present images which change over time.

However, it is also possible for the various sports equipment items to communicate with one another directly and in this way to coordinate which image content elements are respectively presented on the individual board.

Another way in which an external appliance can prescribe the image contents presented or to be presented is a mobile telephone or PDA (personal digital assistant). The external appliance may be connected to the sports equipment item by means of a cable link, for example, while the sports equipment item is being used (including during breaks in travel) and can also be used as a station for receiving and sending data associated with the sports equipment item. The energy store of the mobile telephone or PDA can also be used for operating the image presentation device.

Exemplary embodiments of the invention will now be described with reference to the appended drawing. In the individual figures of the drawing:

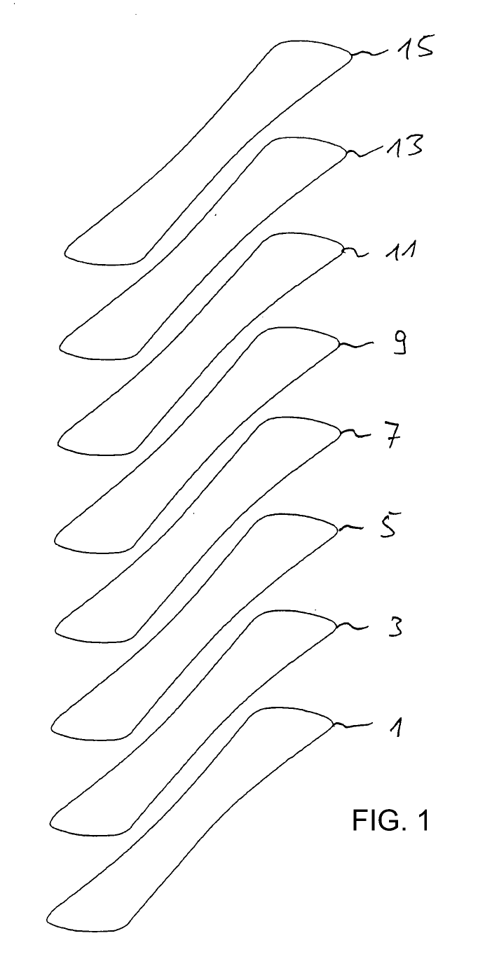

FIG. 1 shows an exploded illustration of a board with eight layers which are arranged above one another and are connected to one another,

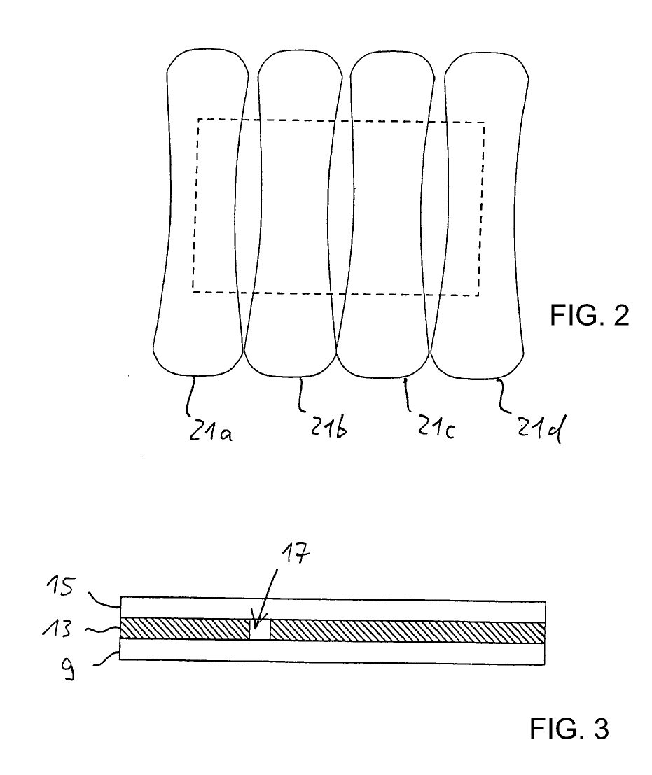

FIG. 2 shows a plurality of boards on which only image content elements of overall image are respectively presented,

FIG. 3 shows the layers shown in FIG. 1, one of the layers being an OLED display,

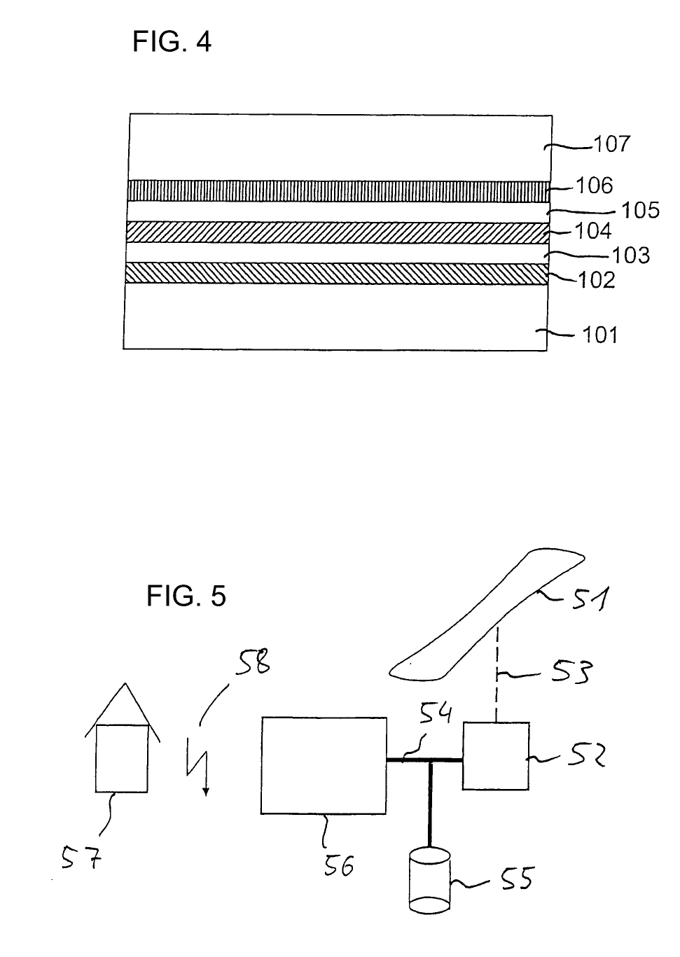

FIG. 4 schematically shows the layer structure of a single OLED,

FIG. 5 schematically shows devices and the connections thereof for operating the image presentation device of a board,

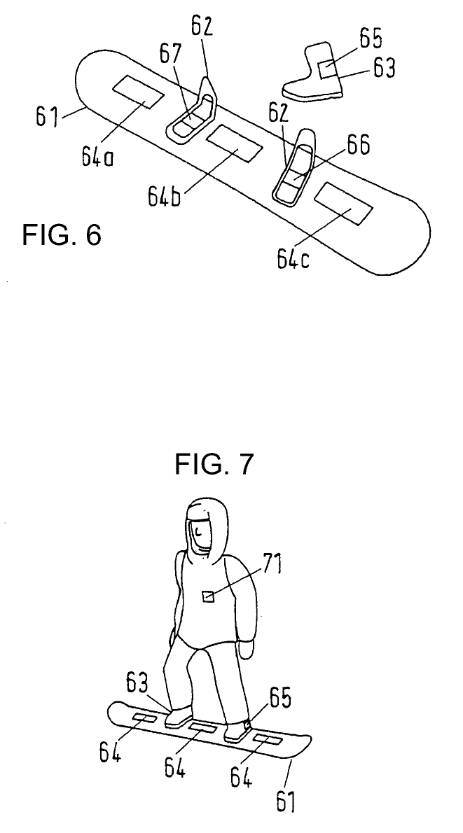

FIG. 6 shows a snowboard with a binding for two snowboard shoes and a suitable shoe, and

FIG. 7 shows a person using the snowboard shown in FIG. 6.

A board based on the present invention may, as now explained with reference to FIG. 1, for example, be constructed from a plurality of layers which are arranged above one another and connected to one another. With the exception of the layer or the layers which are formed by a display, all layers may comprise the materials and be connected to one another as known from the prior art for boards.

In the embodiment shown in FIG. 1, a bottom layer 1 is a polyethylene layer, the bottom surface of which forms the bottom outer surface of the board and serves as a running surface.

FIG. 1 shows a layer 3 above the layer 1. This layer 3 has steel rims which circulate on the outside at the edge of the board at the level of the layer 1 or extend at least on the longitudinal sides of the layer 1. The presentation in FIG. 1 is intended to be understood schematically for layer 3. Layer 3 does not need to be a layer comprising continuous material on which the steel rims are fitted. Instead, the steel rims may also be mounted directly and even as individual segments on the layer 1.

Above the layer 1, there is next a layer 5, for example, comprising fiberglass-reinforced plastic. Above this, there is again provided a layer 7 which forms what is known as the core of the board, that is to say is essentially responsible for the mechanical stability and elasticity of the board. Above this, there may be a second layer 11, comprising fiberglass-reinforced plastic or comprising fiberglass, for example. Over the layer 9, there may be a further layer 11, but this can also be dispensed with. The layer 11 can be used to equalize unevennesses in the layer 13 arranged above it.

If the bottom surface of the layer 13 is sufficiently even, however, the layer 11 can be dispensed with. As will be shown in more detail, the layer 13 may have a flexible polymer as the bottommost sublayer forming its bottom surface. The layer 13 can therefore be connected to the underlying layer 11 or 9 using the same connection techniques (e.g. adhesive bonding) as for the connection of the polyethylene layer 1 to the layer above. The same applies for the connection of the top surface of the layer 13 to the layer 15 above.

As already mentioned, the layer 13 is an OLED display, preferably a PLED (polymer LED) display.

Above the display layer 13, there is a layer 15, e.g. comprising polyethylene, which is transparent to visible radiation and which forms the top surface of the board. This layer can be produced from the same material as is customary for the layer 1, for example.

FIG. 3 schematically shows the display layer 13 and its bottom adjacent layer 9 comprising fiberglass or fiberglass-reinforced plastic and its top adjacent layer 15 comprising a transparent material. An arrow denotes a cutout 17 passing through the display layer 13 from top to bottom in FIG. 3. One or preferably a plurality of such cutouts are provided in the display layer 13 preferably so that mounting means for mounting a binding on the top surface of the board can be inserted into the board. The cutouts can also extend through other layers at the factory, e.g. through the layers 7 to 15.

In one alternative refinement, the board may also additionally have, directly above the bottommost layer 1, in addition to the layers shown in FIG. 1, a second display layer, preferably another PLED display. In this case, the layer 1 is formed from transparent material, which does not necessarily have to be the case in the embodiment shown in FIG. 1. The second display layer means that it is possible both to present images which can be seen when viewing the top surface of the board and to present images which can be seen when viewing the bottom surface of the board.

FIG. 4 shows an OLED structure 100 which has at least one barrier layer 102. A substrate 101 is formed from a flexible (i.e. elastically shape-changing) material which is suitable for use in OLED displays. This substrate can comprise any desired suitable material which is transparent and sufficiently flexible. By way of example, the substrate, may be polymer, for example a polycarbonate, a polyolefin, a polyether sulfone (PES), a polyethylene terephthalate (PET), a polyethylene naphthalate (PEN) or a polyimide. It is therefore possible to refer to a PLED (Polymer Light Emitting Diode) structure. However, it is also possible to use another flexible material, for example, such as paper, tissue, metal foil. Combinations of said flexible materials can also be used for the substrate 101.

To prevent the passage of oxygen and water vapor or at least to reduce it to a low degree (particularly the organic materials of OLEDs can be damaged by oxygen and water vapor), a barrier layer 102 is arranged above the substrate. As described in US 2005/0082971 A1, paragraph 23 and 24, for example, the barrier layer 102 and also a further barrier layer 106 may comprise an inorganic multicomponent glass, e.g. aluminoborosilicate glass, which has been treated as described in the aforementioned paragraphs.

An electrical contact layer 103 having a first polarity is arranged above the barrier layer 102. One or more organic layers 104 (for producing light by means of the effect of electroluminescence in at least one of the organic layers) are arranged above the contact layer 103, and an electrical contact layer 105 having a second polarity is arranged above the organic layer or above the organic layers. The OLED or OLEDs is/are formed from the organic layers 104 and is/are supplied with power via the contact layers 103 and 105 in order to produce an excited energy state. The materials for the organic layers 104 and the contact layers 103 and 105 are known from the literature relating to OLEDs. This also applies to their manner of operation. By way of example, the manner of operation is described in US 2006/0220582 A1, paragraph 5.

The contact layer 103 may be formed from indium tin oxide (ITO), for example. One of the organic layers 104 provided may be a hole conducting layer. Between the contact layer 103 and the hole conducting layer, there may also be arranged a layer comprising PEDOT/PSS (poly(3,4-ethylenedioxythiophene)polystyrenesulfonate) which is used for lowering the injection barrier for holes, smoothes the surface and prevents indium from diffusing into the junction.

The hole conducting layer has a layer applied to it (as part of the organic layers 104) which either contains the dye (e.g. with a dye concentration in a range from 5-10% by volume) or—optionally—completely comprises the electroluminescent dye. By way of example, the dye is tris(8-hydroxychinoline) aluminum. This layer is also referred to as the emitter layer, in which the electroluminescence takes place. This layer (likewise still as part of the organic layers 104) has an electron conducting layer applied to it which, by way of example, is synthesized from tetrahedral tetramers comprising 2,5-diphenyl-substituted 1,3,4-oxadiazole components (for example 2-(4-biphenylyl)-5-(4-tert-butylphenyl)-1,3,4-oxadiazoles (PBD)). For all organic layers 104, it is possible to use the materials cited in US 2006/0220582 A1, paragraphs 26-29, for example.

By way of example, the contact layer 105 can comprise a metal or a metal alloy with a low electron work function (e.g. calcium, aluminum, barium or magnesium/silver alloy) and has been vapor deposited under high vacuum.

A barrier layer 106 has been applied to the contact layer 105, the barrier layer 106 being able to comprise the same material as the barrier layer 102. Besides paragraphs 23 and 24 in US 2005/008297 A1, the exemplary embodiments in FIG. 3 and FIG. 4 of this specification (paragraphs 33 to 39) also describe the refinement of suitable barrier layers.

Alternatively, the materials cited in US 2006/0220582 A1, paragraphs 25 and 30, for example, can be used for the contact layers 103, 105 and the additionally cited optional layers (like layers for reducing the injection barriers).

Optionally, the barrier layer 106 may have a further layer 107 applied to it which is essentially of identical material and thickness to the substrate 101. In addition, other layers may be arranged between the barrier layers, for example, colour filter layers, anti-reflection coatings, light-diffusing films, layers with optical lenses, metal layers or other layers, the function and material of which are known from the prior art for OLEDs.

The embodiment for flexible OLEDs which is described with reference to FIG. 4 may be part of a matrix of OLEDs which form a display for presenting two-dimensional images. As described in US 2006/0220582 A1, paragraphs 6 to 9, the display may be the simple matrix type or the active matrix type. In particular, the active matrix type may be what is known as the top emission type, in which the OLEDs are formed on thin-film transistors (TFTs) or other switch elements. By way of example, the switching function provided by the TFTs allows the individual OLEDs to be activated or deactivated, i.e. to illuminate or not illuminate.

FIG. 11 and FIG. 12 in US 2006/0220582 A1 show the design and operating principle of a single OLED which is part of a display or part of a matrix of OLEDs. The description for these FIGS. 11 and 12 will not be repeated here. It will merely be mentioned that, by way of example, the layers 101 (substrate) and 102 (barrier layer) or the barrier layer 102 and the contact layer 103 may, in line with the previously described embodiment of an OLED (FIG. 4 in this description), have the switch structures and line structures shown in FIG. 11 and FIG. 12 of US 2006/0220582 A1 inserted between them. Additional electrical insulating layers or regions (as shown in FIG. 11 and FIG. 12 of US 2006/0220582 A1) may be provided.

Since the switch structures and line structures comprise very thin material (e.g. comprise a silicon as electrode material), such an OLED with a switching function is likewise flexible and is therefore suitable for use in sports equipment items with boards which are loaded to flexure during use.

FIG. 2 shows an arrangement of four boards 21a to 21d in total. It is possible to see the top of the boards 21, i.e. the top surface is being viewed in the illustration.

A dashed frame whose width extends over all four boards 21 shows that within the frame it is possible to present an overall image, with only the relevant content elements of the overall image being presented on the individual boards 21. Unlike what is shown by the frame, appropriate refinement of the displays of the individual boards allows the content elements also to be presented over the full area of the entire surface of the individual boards. The free regions situated between the boards either have no image content element shown in them or there may also be at least one further display behind the boards which is actuated such that the relevant image content element is presented.

FIG. 5 schematically shows a board 51 which may be of the same design as the board described in FIG. 1, for example. The at least one display in the board 51 has a control device 52 or is connected to the control device 52 by means of a control connection 53. The control device 52 controls a display or the displays in the board 51 in order to present images on the display. In particular the control device 52 controls which pixels of the display(s) illuminate at what time.

By way of example, a data bus 54 connects the control device 52 to an image data store 55 and also to a reception device 56. The reception device 56 can be used to receive new image data and/or control information. The image data store 55 stores image data and/or is used to store newly received image data. When an image is to be presented on the board 51, the control device 52 accesses the image data stored in the image data store 55 and actuates the display(s) such that an appropriate image or appropriate images are presented on the display.

The image data store 55 is a permanent memory, in particular. Instead, a volatile memory may alternatively or additionally also be provided for storing the image data, however, said volatile memory also being able to be part of the control device 52. Particularly in this case, but also in the case of the permanent data store, image information can be presented on the display(s) by the control device 52 directly without accessing a permanent data store, said image information having been transmitted directly from the reception device 56 to the control device 52.

As already mentioned, the devices 52 to 56 are preferably part of the sports equipment item or arranged close to the sports equipment item, so that they are moved together with the sports equipment item. However, FIG. 5 also shows a facility 57 which is remote from the sports equipment item and which is connected or can be connected at least intermittently to the reception device 56 by means of a radio interface 58. Furthermore, there may be further such facilities at other locations. The facility 57 has at least one transmission device which is capable of transmitting the image data and/or the control commands to the reception device 56.

It is particularly possible for only control commands to be transmitted to the reception device 56 and for the control commands to prompt the control device 52 to present image data which are already present in the region of the sports equipment item in another way or to select particular image data for presentation and/or for the control commands to prompt it to immediately switch on or switch off particular pixel regions defined by the control commands.

As an alternative or in addition to the refinement shown in FIG. 5, in which control commands and/or image data are transmitted via a radio interface, the board or another portion of the sports equipment item or the equipment of a user may have a receptacle for receiving a data storage card. By inserting a storage card of this kind, on which control commands and/or image data are stored, the control device can be provided with these commands and/or data.

FIG. 6 shows a snowboard 61 in a three-dimensional illustration from the top. The snowboard 61 has two bindings 62 mounted on it, each for the purpose holding a snowboard shoe 63. Three regions 64a, 64b, 64c are shown which are situated inside the board 61, e.g. in the core or above it. Each of these regions 64 may contain one or more of the aforementioned devices, e.g. an electrochemical energy store, the reception device 56 and/or the control device 52 together with the data store 55. The energy store is charged by electromagnetic fields, for example, externally (what is known as induction charging) when there is a need or opportunity for this. If, as in the embodiment shown in FIG. 1, a display is arranged above the core, the regions 64 are preferably situated beneath this display. This integrated or encapsulated inclusion of devices in the board has the advantages that the devices are well protected from external effects and, in particular, no moisture can penetrate. Furthermore, no appropriate electrical contacts or radio links need to be set up from outside the board into its interior.

The snowboard shoe 63 likewise shown in the FIG. 6 may be provided with an additional device or with one of the devices which may alternatively be arranged in one of the regions 64. The device 65 on the snowboard shoe 63 is, by way of example, a transmission device for sending signals to remote devices, for example is a mobile telephone or is a mobile station which is suitable for a mobile telephone network. Alternatively or in addition, the snowboard shoe 63 may contain a receiver for receiving position signals (e.g. a GPS receiver) and/or a media player.

As yet another alternative or addition, one of the bindings 62 may at least also be provided with a device 66, 67, e.g. with a respective electrochemical energy store, which can again be charged by means of induction or else by connecting a charging cable.

FIG. 7 shows the snowboard 61 from FIG. 6 with a person standing on it who is wearing the snowboard shoe 63. Reference symbol 71 denotes a further device with is integrated in the person's clothing. This device may again be a transmission device, a receiver for receiving position signals and/or a media player.

1-14. (canceled)

15. An item of sports equipment, comprising:
a board formed with a top surface, a bottom surface opposite said top surface, and a lateral face between said top surface and said bottom surface;
at least one image presentation device configured to present an at least two-dimensional image which is visible when viewing said top surface, said bottom surface, and/or said lateral face of said board;
said image presentation device including a matrix of light-emitting diodes configured to display the image.

16. The sports equipment item according to claim 15, wherein said matrix of light-emitting diodes extends along one or both of said top surface and said bottom surface of said board.

17. The sports equipment item according to claim 15, wherein said light-emitting diodes are organic light-emitting diodes.

18. The sports equipment item according to claim 15, wherein said matrix of light-emitting diodes is arranged as a layer or in a layer of said board, and said layer extends along one or both of said top surface and said bottom surface.

19. The sports equipment item according to claim 15, wherein said matrix defines an image area for presenting images extending over at least 50% of a width or at least 50% of a length of at least one of said top surface and said bottom surface.

20. The sports equipment item according to claim 19, wherein said image area extends over the entire width and the entire length of one or both of said top surface and said bottom surface.

21. The sports equipment item according to claim 15, wherein said image presentation device includes a display fully integrated in said board.

22. The sports equipment item according to claim 21, which comprises translucent material covering said display and forming said top surface or said bottom surface.

23. The sports equipment item according to claim 21, wherein said translucent material is a transparent material.

24. The sports equipment item according to claim 15, wherein said image presentation device includes a control device configured to control an image or images to be presented by said image presentation device, and which further comprises a receiving device for receiving image data, and wherein said control device is configured to cause received image data to be presented by said image presentation device.

25. The sports equipment item according to claim 15, wherein said image presentation device includes a control device configured to control an image or images to be presented by said image presentation device, and which further comprises a receiving device for receiving control information, and wherein said control device is configured to cause images to be presented based on the received control information.

26. A method for configuring a visual appearance of a sports apparatus having a board with a top surface, an opposite bottom surface, and a lateral face, which comprises:
presenting images with an array of light emitting diodes forming an image presentation device of the sports apparatus, such that at least one image can be seen when viewing the top surface, the bottom surface, and/or the lateral face of the board.

27. The method according to claim 25, which comprises transmitting image data to the sports apparatus and using the image data for displaying at least one image with the image presentation device.

28. The method according to claim 26, which comprises transmitting the image data to the sports apparatus with wireless transmission.

29. The method according to claim 25, which comprises transmitting control information to the sports apparatus, wherein the control information alters and/or prompts the presentation of at least one image displayed by the image presentation device.

30. The method according to claim 28, which comprises transmitting the control information to the sports apparatus with wireless transmission.
